(19) United States
(12) Patent Application Publication
(10) Pub. No.: US 2009/0141692 A1
(43) Pub. Date: Jun. 4, 2009

(54) OPTIMIZED AD HOC NETWORKING

(76) Inventors: Mika KASSLIN, Espoo (FI); Harri Paloheimo, Espoo (FI); Martti E. Virtanen, Helsinki (FI)

Correspondence Address: Locke Lord Bissell & Liddell LLP;Attn: IP Docketing, Three World Financial Center, New York, NY, 10281-2101, US

(21) Appl. No.: 11/948,093

(22) Filed: Nov. 30, 2007

(51) Int. Cl. H04Q 7/24

(52) U.S. Cl. 370/338

(57) ABSTRACT

Method, apparatus, and computer program product embodiments are disclosed to improve network performance for ad hoc WLANs save power in service discovery phase and provide service availability information quickly and independently from the wireless channels used in the WLAN ad hoc networks. The embodiments perform link-local addressing, Multicast Domain Name Service (DNS), and DNS Service Discovery operations one or more channels of an ad hoc IEEE 802.11 Wireless LAN. A protocol handler in a wireless device is coupled between a standard service discovery protocol module in the device, such as a Zeroconf protocol module or a UPnP protocol module, and at least one internet protocol stack in the device. The Transport, Internet, and Network Interface layers of the IP protocol stack are mapped by the protocol handler to corresponding functions in the standard service discovery protocol module, using a service table for storing information on relationships between available services, wireless devices, and channels on one or more ad hoc wireless networks.

### FIELD

The embodiments disclosed relate to improvements in wireless ad hoc network communication with Internet Protocol (IP) networking.

### BACKGROUND

Short Range Wireless Systems

Short range wireless systems have a typical range of approximately one hundred meters or less. They often combine with systems wired to the Internet to provide communication over long distances. The category of short range wireless systems includes wireless personal area networks (PANs) and wireless local area networks (LANs). They have the common feature of operating in unlicensed portions of the radio spectrum, usually either in the 2.4 GHz Industrial, Scientific, and Medical (ISM) band or the 5 GHz Unlicensed-National Information Infrastructure (U-NII) band. Wireless personal area networks, such as Bluetooth networks, use low power wireless devices that have a typical range of ten meters. Wireless local area networks, such as IEEE 802.11 Wireless LAN networks, generally operate at peak speeds of between 10 to 100 Mbps and are typically used as wireless links of up to 100 meters in range between portable laptop computers and a wired LAN access point (AP).

Ad Hoc Networks

An ad hoc network is a short range wireless system composed primarily of mobile wireless devices which associate together for a relatively short time to carry out a common purpose. A temporary network such as this is called an “independent basic service set” (IBSS) in the IEEE 802.11 Wireless LAN Standard. Ad hoc networks have the common property of being an arbitrary collection of wireless devices which are physically close enough to be able to communicate and which are exchanging information on a regular basis. The networks can be constructed quickly and without much planning. Members of the ad hoc network join and leave as they move into and out of the range of each other. Most ad hoc networks operate over unlicensed radio frequencies at speeds of up to fifty-four Mbps using carrier sense protocols to share the radio spectrum. Ad hoc networks consist primarily of mobile wireless devices.

The IEEE 802.11 Wireless LAN Standard

The IEEE 802.11 Wireless LAN Standard defines one common medium access control (MAC) specification and includes several over-the-air modulation techniques that all use the same basic MAC protocol. The 802.11a standard operates in 5 GHz band, and uses orthogonal frequency-division multiplexing (OFDM) with a maximum data rate of 54 Mbit/s. The 802.11b standard uses the 2.4 GHz band and direct sequence spread spectrum (DSSS) modulation to deliver up to 11 Mbps data rates. The 802.11g standard uses the 2.4 GHz band, and builds on top of the 802.11b standard providing data rates up to 54 Mbps with OFDM based modes similar to the ones in 802.11a. The IEEE 802.11 Wireless LAN Standard describes two major components, the mobile station and the fixed access point (AP). IEEE 802.11 ad hoc networks have an independent configuration where the mobile stations can communicate directly with one another, without support from an access point. IEEE 802.11 ad hoc networks support distributed activities wherein an arbitrary collection of wireless devices are physically close enough to be able to communicate and exchange beacon information. In addition to direct communication between the stations of the IEEE 802.11 ad hoc network, there may be hidden-terminals only accessible by multiple hops, where node A communicates with node B and Node B communicates with node C, but node C is outside of node A's carrier-sensing range and node A's packet transmission to B is not received at node C. It is not necessary that all of the stations be in connection with each other. Although, the standard does not provide support for device discovery or communication in a multi-hop network, an IEEE 802.11 ad hoc network may comprise of mobile stations that do not directly communicate with each other.

IEEE 802.11 ad hoc networks have an independent configuration where the mobile stations communicate directly with one another. The medium access control (MAC) protocol regulates access to the RF physical link. The MAC provides a basic access mechanism with clear channel assessment, channel synchronization, and collision avoidance using the Carrier sense Multiple Access (CSMA) principle. It also provides network inquiring, which is an inquiry and scan operation. The MAC provides link setup, data fragmentation, authentication, encryption, and power management.

The IEEE 802.11 wireless LAN architecture is built around a basic service set (BSS) of stations that communicate with one another. When all of the stations in the BSS are mobile stations and there is no connection to a backbone network providing distributed services, the BSS is called an independent BSS (IBSS) or ad hoc network. The ad hoc network is the entire network and only those stations communicating with each other, or which are hidden-terminals only accessible by multiple hops in the ad hoc network, are part of the LAN. An ad hoc network is typically a short-lived network, with a small number of stations, which is created for a particular purpose, e.g., to exchange data with a vending machine or to collaborate with other stations. In an ad hoc network, the mobile stations all communicate directly with one another or are hidden-terminals only accessible by multiple hops. Thus, if one mobile station must communicate with another, they must be in direct communication range or communicate through multiple hops.

Synchronization is the process of the stations in an IEEE 802.11 ad hoc network getting in step with each other, so that reliable communication is possible. The MAC provides the synchronization mechanism to allow support of physical layers that make use of frequency hopping or other time-based mechanisms where the parameters of the physical layer change with time. The process involves beaconing to announce the presence of an ad hoc network and inquiring to find an ad hoc network. Once an ad hoc network is found, a station joins the ad hoc network. This process is entirely distributed in ad hoc networks and relies on a common timebase provided by a timer synchronization function, which maintains a timer and is updated by information from other stations. When a station begins operation, it resets the timer to zero. The timer may be updated by information received in Beacon frames.

In an IEEE 802.11 ad hoc network, there is no access point (AP) to act as the central time source for the ad hoc network. In an ad hoc network, the timer synchronization mechanism is completely distributed among the mobile stations of the ad hoc network. Since there is no AP, the mobile station that starts the ad hoc network will begin by resetting its timer to zero and transmitting a Beacon, choosing a beacon period. This establishes the basic beaconing process for this ad hoc network. After the ad hoc network has been established, each station in the ad hoc network will attempt to send a Beacon after the target beacon transmission time arrives. To minimize actual collisions of the transmitted Beacon frames on the medium, each station in the ad hoc network will choose a random delay value, which it will allow to expire before it attempts its Beacon transmission. If the station receives a beacon from another station in the network when waiting for the delay to expire, it will not transmit its own beacon.

In order for a mobile station to communicate with other mobile stations in an ad hoc network, it must first find the stations. The process of finding another station is either by passive listening or active inquiry. Passive listening involves only listening for IEEE 802.11 traffic. Active inquiry requires the inquiring station to transmit and invoke responses from IEEE 802.11 stations.

Active inquiry allows an IEEE 802.11 mobile station to find an ad hoc network while minimizing the time spent inquiring. The station does this by actively transmitting queries that invoke responses from stations in an ad hoc network. In an active inquiry, the mobile station will move to a channel and transmit a probe request frame. If there is an ad hoc network on the channel that matches the service set identity (SSID) in the probe request frame, the responding station in that ad hoc network will respond by sending a probe response frame to the inquiring station. This probe response includes the information necessary for the inquiring station to extract a description of the ad hoc network. The inquiring station will also process any other received probe response and Beacon frames. Once the inquiring station has processed any responses, or has decided there will be no responses, it may change to another channel and repeat the process. At the conclusion of the inquiry, the station has accumulated information about the ad hoc networks in its vicinity.

Once a station has performed an inquiry that results in one or more ad hoc network descriptions, the station may choose to join one of the ad hoc networks. The joining process is a local process that occurs internal to the IEEE 802.11 mobile station. Joining an ad hoc network requires that all of the mobile station's MAC and physical parameters be synchronized with the desired ad hoc network. To do this, the station must update its timer with the value of the timer from the ad hoc network description, modified by adding the time elapsed since the description was acquired. This will synchronize the timer to the ad hoc network. The basic service set ID (BSSID) of the ad hoc network must be adopted, as well as the parameters in the capability information field. Once this process is complete, the mobile station has joined the ad hoc network and is ready to begin communicating with the stations in the ad hoc network.

The general IEEE 802.11 frame format begins with a MAC header. The start of the header is the frame control field, followed by a field that contains the duration information for network allocation. This is followed by three addressing fields and frame sequence information. The final field of the MAC header is a fourth address field. Not all of these fields in the MAC header are used in all frames. Following the MAC header is the frame body, which contains the MAC service data unit (MSDU) from the higher layer protocols. The final field in the MAC frame is the frame check sequence. The frame body field contains the information specific to the particular data or management frames. This field is variable length and may be as long as 2304 bytes, which allows an application to send 2048-byte pieces of information, which can then be encapsulated by as many as 256 bytes of upper layer protocol headers and trailers.

The IEEE 802.11 Wireless LAN Standard is published by the Institute of Electrical and Electronics Engineers, Inc.

The Internet Protocol Suite

If conditions were perfect in the wireless communication between two wireless devices, a network interface layer, such as the IEEE 802.11 WLAN medium access control (MAC) layer would suffice to enable data to be passed from the application program in a device to its wireless hardware and successfully transmitted over the wireless medium to the receiving application program in the receiving device. However, real-world networks have hardware failures, network congestion, packet delay or loss, data corruption, and data duplication or sequence errors, which must be dealt with and which are not typically addressed in a network interface layer. Moreover, complex data communication networks do not use a single protocol to handle all transmission tasks. Instead, they require a set of cooperative protocols in a protocol suite. The Transmission Control Protocol (TCP) and the Internet Protocol (IP) (known as the TCP/IP protocol suite or Internet protocol suite) is organized into four conceptual layers that build on the hardware layer. The Application, Transport, Internet, and Network Interface layers are collectively referred to as an IP protocol stack.

The Application Layer: At the highest level, users invoke application programs that access services available across a TCP/IP internet. An application interacts with a transport layer below it, to send or receive data. Each application program chooses the form of transport it needs, either a sequence of individual messages or a continuous stream of bytes. The application program passes data in the required form to the transport layer below it for delivery.

The Transport Layer: The next layer below the application layer is the transport layer. The transport layer provides end-to-end communication from one application program on a sending device to another application program on a receiving device. The transport layer may regulate the flow of information and provide reliable transport to ensure that data arrives without error and in sequence. The transport layer software has the receiving side send back acknowledgements and the sending side retransmit lost packets. The transport layer software divides the stream of data being transmitted into packets and passes each packet along with a destination address to the next layer below, the Internet layer, for transmission. The transport layer adds additional information to each packet, including identifying which application program sent the packet and which application program is to receive it, as well as a checksum. The receiving device uses the checksum to verify that the packet arrived intact and uses the destination code to identify the application program to which the packet is to be delivered.

The Internet Layer: The next layer below the transport layer is the Internet layer. The Internet layer handles communication from one device to another. It accepts a request to send a packet from the transport layer along with an identification of the device to which the packet is to be sent. The Internet layer encapsulates the packet in an IP datagram, fills in the datagram header, uses a routing algorithm to determine whether to deliver the datagram directly to the receiving device or send it to a router, and passes the datagram to the next layer below, the network interface layer, for transmission. The Internet layer also handles incoming datagrams, checking their validity, and uses the routing algorithm to decide whether the datagram should be processed locally or forwarded to another device in the network. For datagrams addressed to the local device, software in the Internet layer deletes the datagram header and passes the packet up to the transport layer above the Internet layer.

The Network Interface Layer: The lowest layer in the Internet protocol suite is the network interface layer, which accepts datagrams from the Internet layer above it and passes it to the device's hardware for transmission over the network. In the discussion herein of WLANs, the network interface layer is the IEEE 802.11 WLAN medium access control (MAC) layer, which passes the MAC frames to the device's wireless hardware for transmission over the wireless medium, as discussed above.

Zero Configuration Networking

Zero Configuration Networking or Zeroconf is the name for a set of technologies to allow two or more computers to communicate with each other without any external configuration. The three technologies that make Zeroconf work are link-local addressing, Multicast Domain Name Service (DNS), and DNS Service Discovery.

Link-Local Addressing: In link-local addressing, Zeroconf-capable devices select an address at random within a prescribed range, send Address Resolution Protocol (ARP) requests to test whether any other device within range uses the same address, and if no responses are received, the device proceeds to use that address.

Multicast DNS: In Multicast DNS, a name is selected by the user and the device sends multicast DNS queries to test whether any other device within range uses the same name, and if no responses are received, the device proceeds to use that name.

DNS Service Discovery: In DNS Service Discovery, client devices in the network query the network infrequently, for example once per hour, to determine what services are available from server devices in the network. Additionally, when a service starts up on a server device, it sends several multicast announcement packets to enable client devices to become aware of the new service, before the clients perform their next scheduled query. IP Multi-cast addresses are special destination addresses that cause packets to be delivered to all interested parties on the local network, rather than only to a single device. Each client device updates a user interface list in the device with the received information in the multicast announcement packets on the new service available from the server device. When a client device attempts to contact a stale service listed on its user interface list, which is no longer available, the failure is noted, and the service is promptly removed from the list of available services maintained by the device. This removal occurs not only on the client device that directly experienced the failure, but also on all the other client devices on the same network link, which passively observe the failure and update their own lists.

The Zeroconf peer-to-peer, multicast-based protocol is effective for small networks, because it is reliable and requires no dedicated service-discovery infrastructure. However, as the network grows in size, having every device multicasting to every other device imposes excessive overhead. Beyond a certain network size, existing service-discovery protocols must transition from using peer-to-peer multicast to a centralized repository to hold service information. Server and client devices in large networks communicate with the centralized repository using a wide-area protocol, such as a standard DNS protocol with two extensions: Update Leases and Long-Lived Queries. Update Leases allows the expiration of server records in a DNS server if the service that created them fails, and Long-Lived Queries allows a client device to be notified as available services change.

There are several published standards and guidelines for Zeroconf. The Internet Engineering Task Force (IETF) published as a standard for Link-Local Addressing, RFC 3927 entitled “Dynamic Configuration of IPv4 Link-Local Addresses,” March 2005, by S. Cheshire, et al. The IETF published as an informational document for Multicast DNS, RFC 4795 entitled “Link-Local Multicast Name Resolution (LLMNR),” January 2007, by B. Aboba, et al. The IETF published as standards for DNS Service Discovery, RFC 2608 entitled “Service Location Protocol, Version 2,” June 1999, by E. Guttman, et al. and RFC 3224 entitled “Vendor Extensions for Service Location Protocol, Version 2,” January 2002 by E. Guttman. These publications are incorporated herein by reference for their description of Zeroconf features.

Universal Plug and Play

Universal Plug and Play (UPnP) is a networking architecture that provides compatibility among networking equipment, software and peripherals of vendors who belong to the Universal Plug and Play Forum. A UPnP control point is a control device that is capable of discovering and controlling client devices in a network through a Web or program interface. The UPnP protocol includes the steps of discovery, description, control, event notification, and presentation.

Discovery: The first step in UPnP networking is discovery, based on a previously known IP address of a client device. When a device is added to the network, the UPnP discovery protocol allows that device to advertise its services to control points on the network. Similarly, when a control point is added to the network, the UPnP discovery protocol allows that control point to search for devices of interest on the network. The fundamental exchange in both cases is a discovery message containing a essential information about the device or one of its services, for example, its type, identifier, and a pointer to more detailed information. The UPnP discovery protocol is based on the Simple Service Discovery Protocol (SSDP).

Description: The next step in UPnP networking is description. After a control point has discovered a device, the control point must retrieve the device's description from a URL provided by the device in the discovery message. For each service, the description includes a list of the commands, or actions, to which the service responds.

The Control, Event notification, and Presentation steps of UPnP deal with real-time operation of the client devices in the network using the control point.

A UPnP protocol known as “Simple Service Discovery Protocol (SSDP)” employs HTTP notification announcements providing a service-type URI and a Unique Service Name (USN). SSDP is described in the published IETF working draft entitled “Simple Service Discovery Protocol/1.0 Operating without an Arbiter,” Oct. 28, 1999, by Y. Goland, et al. This publication is incorporated herein by reference for its description of UPnP features.

The existing problem in the field of ad hoc WLANs is that unlike the infrastructure mode, there is no entity in the ad hoc wireless network that is always present and thus is a natural point to provide networking services, due to the lack of a network hierarchy. Consequently, the standard Zeroconf and UPnP protocol sets are not very well suited for ad hoc WLANs. What is needed is an improvement in network performance for ad hoc WLANs and better conservation of power in the service discovery phase. What is also needed is a way to hide the specifics of the WLAN network interface layer from the standard Zeroconf and UPnP protocol sets. As the end user is only interested in services provided in available WLAN ad hoc networks, there is a need to provide a way to quickly acquire information about available services in all the networks, independent of the wireless channels used by the networks.

### SUMMARY

Method, apparatus, and computer program product embodiments are disclosed to improve network performance for ad hoc WLANs, save power in service discovery phase and provide service availability information quickly and independently from the wireless channels used in the WLAN ad hoc networks. The embodiments perform link-local addressing, Multicast Domain Name Service (DNS), and DNS Service Discovery operations over channels of an ad hoc IEEE 802.11 Wireless LAN. A protocol handler in a wireless device is coupled between a standard service discovery protocol module in the device, such as a Zeroconf protocol module or a UPnP protocol module, and an internet protocol stack in the device. The Transport, Internet, and Network Interface layers of the IP protocol stack are mapped by the protocol handler to corresponding functions in the standard service discovery protocol module, using a service table for storing information on relationships between available services, wireless devices, and channels on one or more ad hoc wireless networks.

The protocol handler in a wireless device a) determines link local addresses common for all networks/channels for the discovery phase; b) records information about services provided by the device itself; c) detects ad hoc networks formed by stations having a similar, peer protocol handling entity (for example, detecting a vendor specific field in beacons); d) runs the “service discovery protocol” with a peer protocol handling entity in a peer device the network (if one is detected); e) provides standard network interface services locally to the IP stack and Zeroconf/UPnP protocols by mapping the “service discovery protocol” messages received from the peer device's protocol handler into standard Zeroconf/UPnP protocol messages.

The protocol handler has control over the device's WLAN ad hoc network discovery and connection management. The protocol handler prioritizes service discoveries with those devices that have a corresponding protocol handler, before it interacts with other devices that do not have one. This enables the device to run service discovery first in those networks having peer devices transmitting a vendor specific field in their beacon indicating that the peer devices have a similar protocol handler.

In WLAN ad hoc network discovery and connection management during the discovery phase, the protocol handler first commands the IEEE 802.11 WLAN medium access control (MAC) layer in the IP protocol stack to perform a WLAN scan in selected channels. After the discovery phase, a first WLAN ad hoc network is selected to which a WLAN connection is created. In the network selection, those networks and devices that have a corresponding protocol handler are given a higher priority and are selected first. The protocol handler commands the MAC layer to connect to a given WLAN ad hoc network detected in the discovery phase. Upon the first successful creation of a WLAN connection during the service discovery phase, the protocol handler keeps the WLAN connection open for the upper layers of the IP protocol stack. Even when moving from one WLAN ad hoc network to another, the protocol handler keeps the WLAN connection open for the upper layers by buffering transmission requests for a later phase when connection to the new network has been created. The protocol handler keeps the WLAN connection open throughout the whole discovery phase. In this manner, the client side's protocol handler keeps a WLAN ad hoc connection “open” even if the device moves from one ad hoc network to another. This procedure makes possible requiring only one TCP connection and IP address for the entire lifetime of the application running on the device. By contrast, this is generally unnecessary on the server side since a server device typically operates its own ad hoc network and does not generally move from one network to another.

In WLAN connection management, when a service and an associated WLAN ad hoc network and device are selected from the services previously detected during the discovery phase, the protocol handler commands the IEEE 802.11 WLAN medium access control (MAC) layer in the IP protocol stack to connect to the network. For the upper layers of the IP protocol stack, the protocol handler keeps the WLAN connection open while the MAC layer is connecting to the selected network. The protocol handler updates a service table accordingly and starts using the address associated to the selected network and channel with the service.

In link-local addressing, the standard service discovery protocol module (Zeroconf/UPnP) selects a trial address at random for each of the one or more channels in which an interesting WLAN ad hoc network is detected. The protocol handler coupled between the standard service discovery protocol module and the internet protocol stack, records each of the addresses in the service table and passes each address to a respective one of the Internet layers in the IP protocol stack. The Internet layers pass the respective address down to the IEEE 802.11 WLAN medium access control (MAC) layer in the IP protocol stack. The protocol handler controls the MAC layer for each of the one or more channels and sends an Address Resolution Protocol (ARP) request packet to the respective radio in the device tuned to transmit on the respective channel, to test whether any other ad hoc wireless device within range on the same channel, uses the same trial address. Lack of responses on the respective channel will be noted in the protocol handler, which records in the service table that the trial address is confirmed as being a valid address for use by the device on that channel. Valid addresses are then established for the device on each of the channels.

In Multicast domain name services (DNS), a trial device name is selected by the user for each of the channels or the same name can be chosen for all of the channels, and the name is passed to the standard service discovery protocol module (Zeroconf/UPnP). The protocol handler coupled between the standard service discovery protocol module and the internet protocol stack, records each of the trial names in the service table and passes each trial name to a respective one of the Internet layers in the IP protocol stack. The Internet layers pass the respective trial name down to the IEEE 802.11 WLAN medium access control (MAC) layer in the IP protocol stack. The protocol handler controls the MAC layer for each of the one or more channels to pass a multicast DNS query packet containing the respective trial name down to the radio in the device tuned to the respective channel. The radio sends multicast DNS query packets on the respective channel to test whether any other ad hoc wireless device within range on that channel uses the same trial name. Lack of responses on the respective channel will be noted in the protocol handler, which records in the service table that the trial name is confirmed as being a valid name for use by the device on that channel. Valid names (which can be the same name) are then established for the device on each of the channels.

In DNS Service Discovery, the standard service discovery protocol module (Zeroconf/UPnP) signals the protocol handler coupled between the standard service discovery protocol module and the internet protocol stack, to control the IP protocol stack for each channel to query the network infrequently, for example once per hour, to determine what services are available from server devices in the network. The protocol handler checks for existing network services for each channel in the service table, and passes the addresses of existing network services to a respective one of the Internet layers in the IP protocol stack. The Internet layers pass the respective addresses of existing network services down to the IEEE 802.11 WLAN medium access control (MAC) layer in the IP protocol stack. The protocol handler controls the MAC layer for each of the one or more channels. The MAC layer is controlled to pass down to the radio in the device tuned to the respective channel, a multicast query packet to search for new services on the channel. The MAC layer is controlled to pass down to the radio in the device, packets with addresses of existing network services to check for the continued existence of those network services. The radio sends multicast packets on the respective channel to query the network to determine what services are available from server devices in the network. Responses indicating available services on the channel are received by the radio and MAC layer and this is reported back to the protocol handler, which records in the service table the discovered service name, address, and description for use by the device on that channel. Discovered services are then recorded in the service table for the device on each of the channels.

Additionally, in DNS Service Discovery, when a service starts up on the device operating as a server, the standard service discovery protocol module (Zeroconf/UPnP) signals the protocol handler coupled between the standard service discovery protocol module and the internet protocol stack, to control the IP protocol stack for each channel to send several multicast announcement packets with IP multicast addresses to enable all client ad hoc wireless devices on the channel to become aware of the new service, before the clients are scheduled to perform their next scheduled query. The protocol handler in each client device updates its respective service table of available services, with the received information in the multicast announcement packets, to add the new service available from the server device. When a client device attempts to contact a stale service listed in its service table, which is no longer available on the channel, the failure is noted and the service is promptly removed from the service table maintained by the protocol handler in the device. This removal occurs not only on the client device that directly experienced the failure, but also on all the other client devices on the same channel, which passively observe the failure and update their own lists.

Embodiments can exchange service discovery packets over one or more channels of an ad hoc wireless network using a protocol handler coupled between a standard service discovery protocol module (Zeroconf/UPnP) and the internet protocol stack. The protocol handler can store information on relationships between available services, wireless devices, and channels on the ad hoc wireless network in a service table coupled to the protocol handler. When operating in the client mode, the protocol handler can receive a service discovery protocol inquiry message from the standard service discovery protocol module and transfer a copy the inquiry message to the internet protocol stack for respective transmission over the one or more channels of the ad hoc wireless network. The protocol handler can receive one or more service response messages respectively from the internet protocol stack, the messages having been respectively received by the internet protocol stack, for services available from wireless devices respectively operating on the one or more channels of the ad hoc wireless network, and store information in the service table about the services indicated as available in the response messages.

In embodiments operating in the server mode, the protocol handler can further receive a service discovery protocol announcement message from the standard service discovery protocol module (Zeroconf/UPnP) and transfer a copy the announcement message to the internet protocol stack for respective transmission over the one or more channels of the ad hoc wireless network. Server embodiments can further respectively transmit a beacon packet from the internet protocol stack over the one or more channels of the ad hoc wireless network, specifying times for transmission of the service discovery protocol announcement message.

The resulting embodiments provide an improvement in network performance for ad hoc WLANs and better conservation of power in the service discovery phase.

### DESCRIPTION OF THE FIGURES

FIG. 1 illustrates an external view and a functional block diagram of an example embodiment of the wireless device 100.

FIG. 2 illustrates a functional block diagram of the wireless device 100 operating as a client device running an audio application and searching for services in the discovery phase on two different channels.

FIG. 2A is a simplified flow diagram of an example of link-local addressing in an embodiment of the invention.

FIG. 2B is a simplified flow diagram of an example of Multicast Domain Name Service (DNS) in an embodiment of the invention.

FIG. 2C is a simplified flow diagram of an example of the Device Client Mode in an embodiment of the invention.

FIG. 2D is a more detailed flow diagram of an example of the Device Client Mode in an embodiment of the invention.

FIG. 2E illustrates the service tables to provide linkage between services, devices, and WLAN channels in each of three respective wireless devices.

FIG. 3 illustrates a functional block diagram of the wireless device 100 operating as a server device running an advertising application and sending out announcement messages about the availability of its services over two different channels.

FIG. 3A is a simplified flow diagram of an example of the Device Server Mode in an embodiment of the invention.

FIG. 3B illustrates a timing diagram for transmitting the multicast announcement packets on two channels.

FIG. 4 illustrates a timing diagram for transmitting the beacon frame to send a forecast of the timing for transmissions of service announcements.

FIG. 5 illustrates an example frequency spectrum for WLAN Band Allocation of channels.

### DISCUSSION OF EXAMPLE EMBODIMENTS

The method, apparatus, and computer program product embodiments improve network performance for ad hoc WLANs and achieve better conservation of power in the service discovery phase.

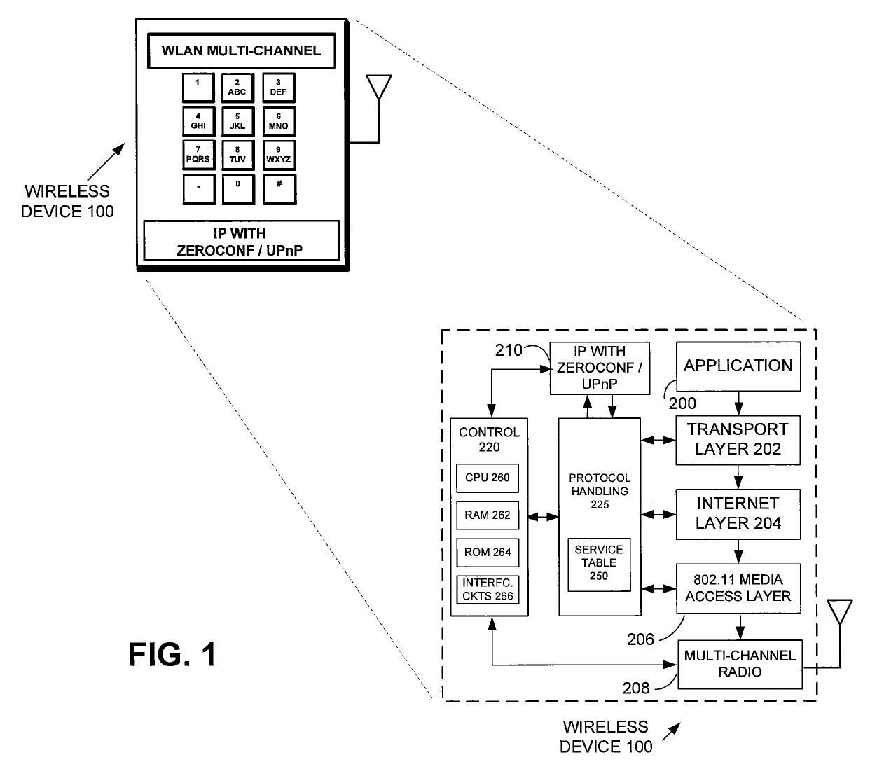

FIG. 1 illustrates an external view and a functional block diagram of an example embodiment of the wireless device 100. The wireless device 100 can be a mobile communications device, PDA, cell phone, laptop or palmtop computer, or the like. The wireless device 100 includes a control module 220, which includes a central processing unit (CPU) 260, a random access memory (RAM) 262, a read only memory (ROM) 264, and interface circuits 266 to interface with the radio 208, battery and other power sources, key pad, touch screen, display, microphone, speakers, ear pieces, camera or other imaging devices, etc. in the devices 100, 100′, and 100″. The RAM 262 and ROM 264 can be removable memory devices such as smart cards, SIMs, WIMs, semiconductor memories such as RAM, ROM, PROMS, flash memory devices, etc. The protocol handler 225, standard service discovery protocol module 210, internet protocol stacks 202, 204, 206, service table 250, and/or application program 200 can be embodied as program logic stored in the RAM 262 and/or ROM 264 in the form of sequences of programmed instructions which, when executed in the CPU 260, carry out the functions of the disclosed embodiments. The program logic can be delivered to the writeable RAM, PROMS, flash memory devices, etc. 262 of the device 100 from a computer program product or article of manufacture in the form of computer-usable media such as resident memory devices, smart cards or other removable memory devices, or in the form of program logic transmitted over any transmitting medium which transmits such a program. Alternately, the protocol handler 225, standard service discovery protocol module 210, internet protocol stacks 202, 204, 206, service table 250, and/or application program 200 can be embodied as integrated circuit logic in the form of programmed logic arrays or custom designed application specific integrated circuits (ASIC). The radio 208 in device 100 can be separate transceiver circuits for each respective channel 1, channel 2, etc. Alternately, the radio 208 in the device 100 can be a single radio module capable of handling one or multiple channels in a high speed, time and frequency multiplexed manner in response to the control module 220.

Example Client Mode for Device 100

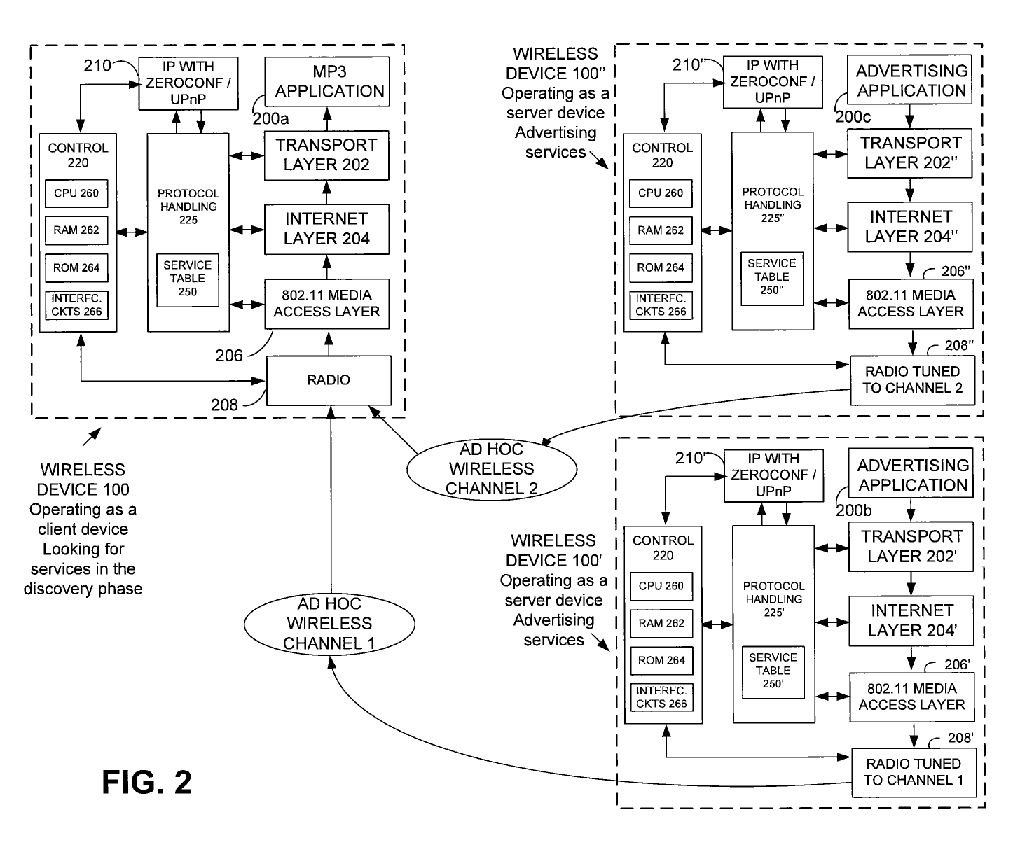

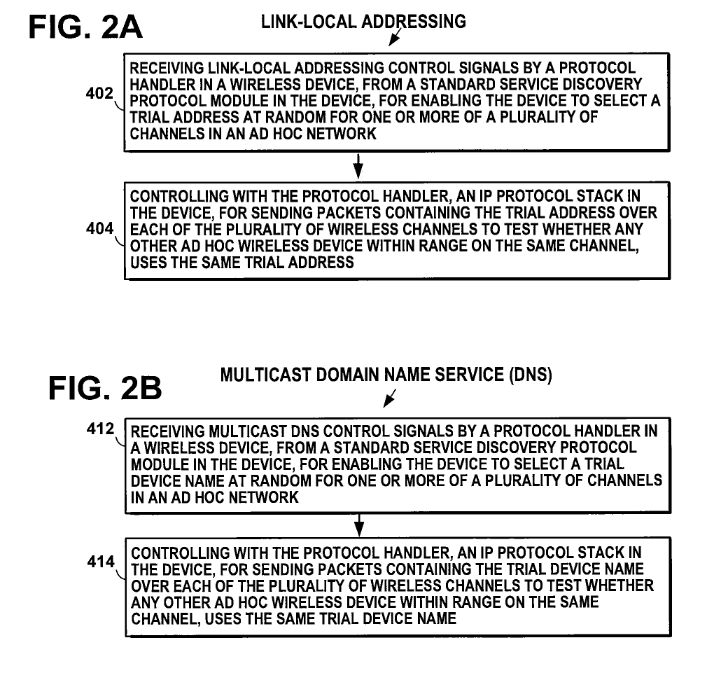

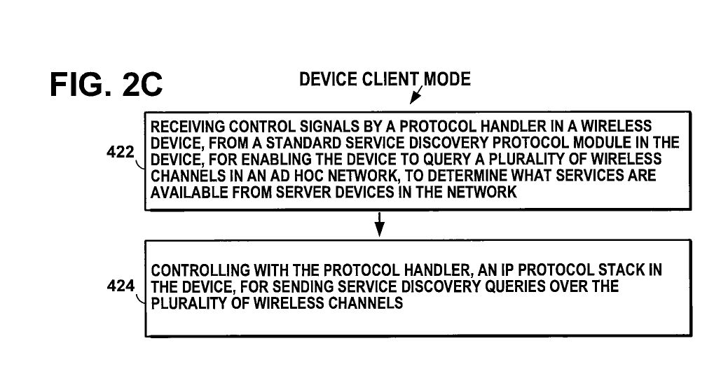

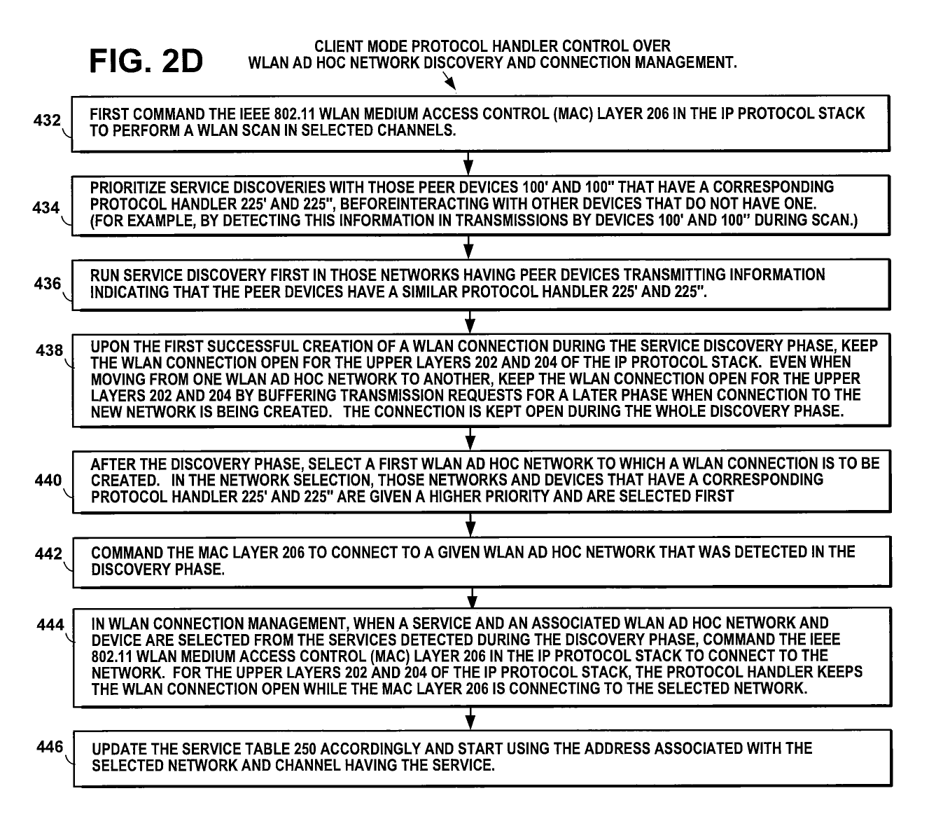

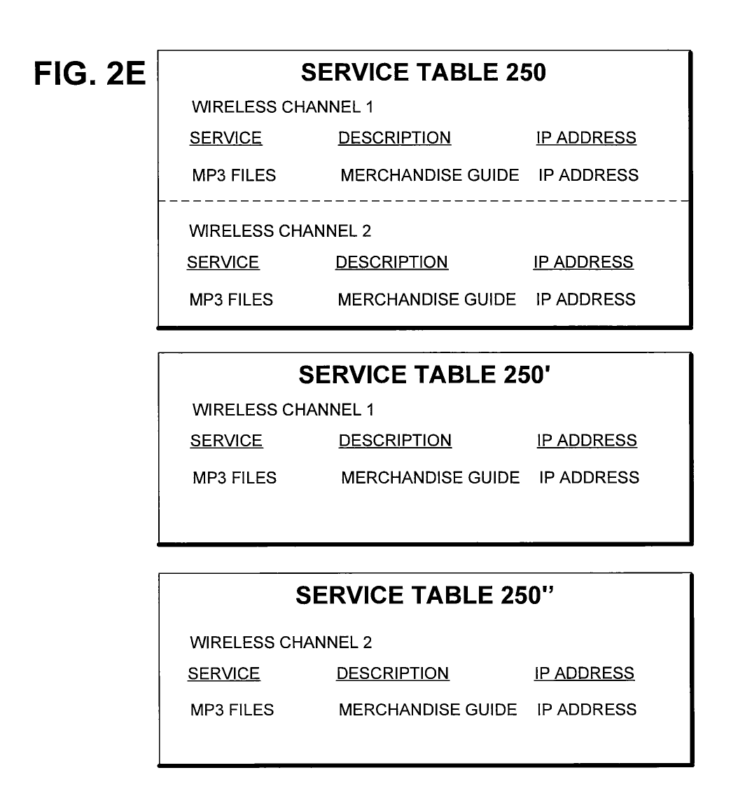

In the embodiment of FIG. 2, the wireless device 100 is operating as a client device running an MP3 audio application 200a and is searching for services in the discovery phase on both of the channels, 1 and 2. The wireless devices 100′ and 100″ in FIG. 2 are operating as server devices running respective advertising applications 100b and 100c. Device 100′ is sending out announcement messages about the availability of its services on channel 1 and device 100″ is sending out announcement messages about the availability of its services on channel 2. The wireless devices 100′ and 100″ in FIG. 2 have similar architectures to device 100.

The embodiments perform link-local addressing, Multicast Domain Name Service (DNS), and DNS Service Discovery operations over one or more channels of an ad hoc IEEE 802.11 Wireless LAN. A protocol handler 225 in a wireless device 100 is coupled between a standard service discovery protocol module 210 in the device 100, such as a Zeroconf protocol module or a UPnP protocol module, and at least one internet protocol stack 202, 204, 206 in the device 100. The Transport layer 202, Internet layer 204, and Network Interface layer 206 of the IP protocol stack are mapped by the protocol handler 225 to corresponding functions in the standard service discovery protocol module 210, using a service table 250 for storing information on relationships between available services, wireless devices, and channels on the one or more ad hoc wireless networks.

FIG. 2 illustrates a functional block diagram of the wireless device 100 operating as a client device running an MP3 audio application 200a looking for services in the discovery phase. The protocol handler 225 in the wireless device 100 is coupled between a standard service discovery protocol module 210 in the device 100, such as a Zeroconf protocol module or a UPnP protocol module, and at least one internet protocol stack 202, 204, 206 in the device 100. The Transport layer 202, Internet layer 204, and Network Interface layer 206 of the IP protocol stack are mapped by the protocol handler 225 to corresponding functions in the standard service discovery protocol module 210, using a service table 250 for storing information on relationships between available services, wireless devices, and channels on the one or more ad hoc wireless networks.

Multicast announcement packets are received in the client wireless device 100 of FIG. 2 under the control of the Internet protocol stack that includes a transport layer 202, an Internet layer 204, and an IEEE 802.11 WLAN MAC layer 206 in device 100. The multicast announcement packets are respectively transmitted by the devices 100′ and 100″ operating as server devices, under the control of the Internet protocol stack in each respective server device 100′ and 100″, which includes a transport layer 202′/202″, an Internet layer 204′/204″, and an IEEE 802.11 WLAN MAC layer 206′/206″ in each respective device 100′/100″. Each Internet protocol stack is controlled by a respective Protocol handling module 225′/225″ that maps the protocols in a respective Zeroconf/UPnP service discovery protocol module 210′/210″ optimally to the respective Internet protocol stack 202′/202″, 204′/204″, 206′/206″ with the IEEE 802.11 Wireless LAN MAC protocol 206′/206″ as the network interface layer. The respective Protocol handling module 225′/225″ maintains a respective service table 250′/250″ to provide linkage between services, devices, WLAN channels and WLAN ad hoc networks in each wireless device 100, 100′ and 100″.

The protocol handler 225 in the wireless device 100, operating as a client, in accordance with control signals from the standard service discovery protocol module 210, first determines link local addresses common for all networks/channels for the discovery phase. Then the protocol handler 225, operating in accordance with control signals from the standard service discovery protocol module 210, records information in the service table 250 about services provided by the device 100, itself. Then the protocol handler 225, operating in accordance with control signals from the standard service discovery protocol module 210, detects ad hoc networks formed by devices 100′ and 100″ having a similar, peer protocol handling entity 225′ and 225″ (for example, by detecting a vendor specific field 400 in beacons transmitted by devices 100′ and 100″.) Then the protocol handler 225, operating in accordance with control signals from the standard service discovery protocol module 210, runs the “service discovery protocol” with a peer protocol handling entity 225′ or 225″ in peer device 100′ or 100″, respectively, in the network (if one is detected.) Then the protocol handler 225, operating in accordance with control signals from the standard service discovery protocol module 210, provides standard network interface services locally to the IP stack 202, 204, 206 and Zeroconf/UPnP protocols from the standard service discovery protocol module 210. This is done by mapping the received “service discovery protocol” service announcement messages from the peer protocol handling entities 225′ and 225″ of the peer devices 100′ and 100″, into standard Zeroconf/UPnP protocol messages, announcing services available from the peer devices 100′ and 100″.

The protocol handler 225 of device 100 has control over the device's WLAN ad hoc network discovery and connection management. The protocol handler 225 prioritizes service discoveries with those peer devices 100′ and 100″ that have a corresponding protocol handler 225′ and 225″, before it interacts with other devices that do not have one. This enables the device 100 to run service discovery first in those networks having peer devices that have a similar protocol handler 225′ and 225″. Those peer devices can be detected from a vendor specific field 400, or from a dedicated information element in their beacon and probe response indicating that the peer devices have a similar protocol handler 225′ and 225″.

In WLAN ad hoc network discovery and connection management during the discovery phase, the protocol handler 225 first commands the IEEE 802.11 WLAN medium access control (MAC) layer 206 in the IP protocol stack to perform a WLAN scan in selected channels. After the discovery phase, a first WLAN ad hoc network is selected to which a WLAN connection is created. In the network selection, those networks and devices that have a corresponding protocol handler 225′ and 225″ are given a higher priority and are selected first. The protocol handler 225 commands the MAC layer 206 to connect to a given WLAN ad hoc network that was detected in the discovery phase.

Upon the first successful creation of a WLAN connection during the service discovery phase, the protocol handler 225 keeps the WLAN connection open for the upper layers 202 and 204 of the IP protocol stack. Even when moving from one WLAN ad hoc network to another, the protocol handler 225 keeps the WLAN connection open for the upper layers 202 and 204 by buffering transmission requests for a later phase when connection to the new network has been created. The protocol handler keeps the WLAN connection open throughout the whole discovery phase. In this manner, the client side's protocol handler keeps a WLAN ad hoc connection “open” even if the device moves from one ad hoc network to another. This procedure makes possible requiring only one TCP connection and IP address for the entire lifetime of the application running on the device. By contrast, this is generally unnecessary on the server side since a server device operates its own ad hoc network and does not generally move from one network to another.

In WLAN connection management, when a service and an associated WLAN ad hoc network and device are selected from the services previously detected during the discovery phase, the protocol handler 225 commands the IEEE 802.11 WLAN medium access control (MAC) layer 206 in the IP protocol stack to connect to the network. For the upper layers 202 and 204 of the IP protocol stack, the protocol handler keeps the WLAN connection open while the MAC layer 206 is connecting to the selected network. The protocol handler 225 updates a service table 250 accordingly and starts using the address associated to the selected network and channel with the service.

In link-local addressing, the standard service discovery protocol module 210 selects a trial address at random for one or more of the plural channels. The protocol handler 225 coupled between the standard service discovery protocol module 210 and the internet protocol stack 202, 204, 206, records each of the addresses in the service table 250 and passes each address to a respective one of the Internet layers 204 in the IP protocol stack 202, 204, 206. The Internet layers 204 pass the respective address down to the IEEE 802.11 WLAN medium access control (MAC) layer 206 in the IP protocol stack. The protocol handler 225 controls the MAC layer for each of the one or more channels and sends an Address Resolution Protocol (ARP) request packet to the radio 208 in the device tuned to transmit on the respective channel, to test whether any other ad hoc wireless device within range on the same channel, uses the same trial address. If no responses are received by the radio 208 and MAC layer 206 on the respective channel, this is reported back to the protocol handler 225, which records in the service table 250 that the trial address is confirmed as being a valid address for use by the device on that channel. Valid addresses are then established for the device on each of the channels.

In Multicast domain name services (DNS), a trial device name is selected by the user for each of the channels or the same name can be chosen for all of the channels, and the name is passed to the standard service discovery protocol module 210. The protocol handler 225 coupled between the standard service discovery protocol module 210 and the internet protocol stack 202, 204, 206, records each of the trial names in the service table 250 and passes each trial name to a respective one of the Internet layers 204 in the IP protocol stack. The Internet layers 204 pass the respective trial name down to the IEEE 802.11 WLAN medium access control (MAC) layer 206 in the IP protocol stack. The protocol handler 225 controls the MAC layer 206 for each of the plural channels to pass a multicast DNS query packet containing the respective trial name down to the respective radio 208 in the device tuned to the respective channel. The radio 208 sends multicast DNS query packets on the respective channel to test whether any other ad hoc wireless device within range on that channel uses the same trial name. If no responses are received by the radio 208 and MAC layer 206 on the respective channel, this is reported back to the protocol handler 225, which records in the service table 250 that the trial name is confirmed as being a valid name for use by the device on that channel. Valid names (which can be the same name) are then established for the device on each of the channels.

In DNS Service Discovery, the standard service discovery protocol module 210 signals the protocol handler 225 coupled between the standard service discovery protocol module 210 and the internet protocol stack 202, 204, 206, to control the IP protocol stack for each channel to query the network infrequently, for example once per hour, to determine what services are available from server devices in the network. The protocol handler 225 checks for existing network services for each channel in the service table 250, and passes the addresses of existing network services to a respective one of the Internet layers 204 in the IP protocol stack. The Internet layers 204 pass the respective addresses of existing network services down to the IEEE 802.11 WLAN medium access control (MAC) layer 206 in the IP protocol stack. The protocol handler 225 controls the MAC layer for each of the plural channels. The MAC layer 206 is controlled to pass down to the radio 208 in the device tuned to the respective channel, a multicast query packet to search for new services on the channel. The MAC layer 206 is controlled to pass down to the radio 208 in the device, packets with addresses of existing network services to check for the continued existence of those network services. The radio 208 sends multicast packets on the respective channel to query the network to determine what services are available from server devices in the network. Responses indicating available services on the channel are received by the radio 208 and MAC layer 206 and this is reported back to the protocol handler 225, which records in the service table 250 the discovered service name, address, and description for use by the device on that channel. Discovered services are then recorded in the service table for the device on each of the channels.

Additionally, in DNS Service Discovery, when a service starts up on the device 100, the standard service discovery protocol module 210 signals the protocol handler 225 coupled between the standard service discovery protocol module 210 and the internet protocol stack 202, 204, 206, to control the IP protocol stack for each channel to send several multicast announcement packets with IP multicast addresses to enable all client ad hoc wireless devices on the channel to become aware of the new service, before the clients are scheduled to perform their next scheduled query. The protocol handler 225 in each client device updates its respective service table 250 of available services, with the received information in the multicast announcement packets, to add the new service available from the server device. When a client device attempts to contact a stale service listed in its service table 250, which is no longer available on the channel, the failure is noted and the service is promptly removed from the service table 250 maintained by the protocol handler 225 in the device. This removal occurs not only on the client device that directly experienced the failure, but also on all the other client devices on the same channel, which passively observe the failure and update their own lists.

The resulting embodiments provide an improvement in network performance for ad hoc WLANs and better conservation of power in the service discovery phase.

The Protocol handling module 225 maps the protocols in Zeroconf/UPnP optimally to the Internet protocol suite 202, 204, 206 with the IEEE 802.11 Wireless LAN MAC protocol 206 as the network interface layer. In the case of service inquiries, as an example, Protocol handling module 225 transmits service inquiries to all the relevant WLAN channels and not only to the channel to which the transmitting radio is currently tuned. When gathering responses to such multiplied inquiries Protocol handling module 225 forms responses that are compatible with the Internet protocol suite 202, 204, 206 with the IEEE 802.11 Wireless LAN MAC protocol 206 in terms of content, structure and timing.

The Protocol handling module 225 handles procedures for service inquiries and responses so as to be compatible with the Internet protocol suite 202, 204, 206 with the IEEE 802.11 Wireless LAN MAC protocol 206. The Protocol handling module 225 handles addressing and naming service protocols both in message structure, content and protocol timing perspective so as to be compatible with the Internet protocol suite 202, 204, 206 with the IEEE 802.11 Wireless LAN MAC protocol 206.

FIG. 2A is a simplified flow diagram of an example of link-local addressing in an embodiment of the invention.

In step 402, the protocol handling module 225 receives link-local addressing control signals in the wireless device 100, from the standard service discovery protocol module 210 in the device, such as a Zeroconf protocol module or a UPnP protocol module, for enabling the device to select a trial address at random for one or more of a plurality of channels in an ad hoc network.

In step 404, the protocol handling module 225 controls the IP protocol stack 202, 204, 206 in the device, for sending packets containing the trial address over each of the plurality of wireless channels to test whether any other ad hoc wireless device within range on the same channel, uses the same trial address.

FIG. 2B is a simplified flow diagram of an example of Multicast Domain Name Service (DNS) in an embodiment of the invention.

In step 412, the protocol handling module 225 receives Multicast DNS control signals in the wireless device, from the standard service discovery protocol module 210 in the device, such as a Zeroconf protocol module or a UPnP protocol module, for enabling the device to select a trial device name at random for one or more of a plurality of channels in an ad hoc network.

In step 414, the protocol handling module 225 controls the IP protocol stack 202, 204, 206 in the device, for sending packets containing the trial device name over each of the plurality of wireless channels to test whether any other ad hoc wireless device within range on the same channel, uses the same trial device name.

FIG. 2C is a simplified flow diagram of an example of the Device Client Mode in an embodiment of the invention.

In step 422, the protocol handling module 225 receives control signals in the wireless device, from the standard service discovery protocol module 210 in the device, such as a Zeroconf protocol module or a UPnP protocol module, for enabling the device to query a plurality of wireless channels in an ad hoc network, to determine what services are available from server devices in the network.

In step 424, the protocol handling module 225 controls the IP protocol stack 202, 204, 206 in the device, for sending service discovery queries over the plurality of wireless channels.

In embodiments of the invention, only one TCP connection and IP address are required for the entire lifetime of the application running on the device.

Before the client device 100 begins the discovery phase, the protocol handler 225 performs the WLAN scan for peer devices that have a similar protocol handler 225, and it gives priority to those peer devices that have one.

When the client device 100 begins the discovery phase, the protocol handler 225 goes through the processes of link-local addressing and Multicast Domain Name Service (DNS) to establish a unique address and device name for the device in all of the ad hoc networks that are within communications range. The unique address and device name are then provided to the Internet layer 204 of the IP stack. In one embodiment of the invention, the protocol handler 225 provides the address to the Internet layer 204 without completing the process of link-local addressing. In address conflict cases the protocol handler determines a new candidate address for the WLAN connection as per the link-local addressing rules and protocols. The protocol handler 225 keeps the address for the Internet layer 204 same by performing mapping from the new address in the WLAN connection to the one provided originally to the Internet layer. The protocol handler 225 controls the Internet layer 204 to keep this same unique address and device name for the client device 100 throughout the whole discovery phase. If the client device moves into communication range of a new ad hoc network, the client device 100 will continue to use same unique address and device name, since the probability of having the same address value in the new network is small. It is up to the user to have originally selected a device name that is sufficiently unusual so that the probability of having the same device name in the new network is small.

When the client device 100 moves from one WLAN ad hoc network to another during the discovery phase, the protocol handler 225 keeps the WLAN connection open for the TCP transport layer 202 and Internet layer 204 by buffering transmission requests and parameters from the Zeroconf/UPnP module 210, the application program 200, TCP layer 202, and/or Internet layer 204. For example, the same unique address and device name are buffered for the Internet layer 204. Transport parameters initially established during the discovery phase are buffered for the transport layer 202, such as identifying which program in the client device 100 is sending the packet, the port numbers in the client device 100, etc. This keeps the IP stack open for the upper layers 202 and 204 to enable exchanging service discovery packets over the channels with subsequently discovered ad hoc networks.

This process controlled by the protocol handler 225, is referred to as “keeping the connection open” for the entire lifetime of the application running on the device.

FIG. 2D is a more detailed flow diagram of an example of the Device Client Mode in an embodiment of the invention. The protocol handling module 225 receives control signals in the wireless device, from the standard service discovery protocol module 210 in the device, in performing many of the following steps. The standard service discovery protocol module 210 in the device, can be, for example, a Zeroconf protocol module or a UPnP protocol module. In service discovery operation, the Protocol handling module 225 initially receives a single service discovery protocol message from the service discovery protocol module (Zeroconf/UPnP) 210.

The Protocol handling module 225 handles procedures for service inquiries and responses so as to be compatible with the Internet protocol suite 202, 204, 206 with the IEEE 802.11 Wireless LAN MAC protocol 206. The Protocol handling module 225 handles addressing and naming service protocols both in message structure, content and protocol timing perspective so as to be compatible with the Internet protocol suite 202, 204, 206 with the IEEE 802.11 Wireless LAN MAC protocol 206.

In step 432 of FIG. 2D, the protocol handling module 225 commands the IEEE 802.11 WLAN medium access control (MAC) layer 206 in the IP protocol stack to perform a WLAN scan in selected channels. This step is to find out whether there are networks and devices having a similar Protocol handling module 225. In service discovery phase (Zeroconf/UPnP), a WLAN connection and scanning step is needed to gather information about available ad hoc networks and the presence of a similar Protocol handling module 225 in the peer devices.

In step 434, the protocol handling module 225 prioritizes conducting service discoveries with those peer devices 100′ and 100″ that have a corresponding protocol handler 225′ and 225″, before it interacts with other devices that do not have one. (The existence of a corresponding protocol handler in peer devices can be determined, for example, by detecting a vendor specific field 400 in beacons transmitted by devices 100′ and 100″. Other transmissions from the peer devices can also contain this information.)

In step 436, the protocol handling module 225 runs service discovery first in those networks having peer devices transmitting a vendor specific field 400 in their beacon or other transmissions indicating that the peer devices have a similar protocol handler 225′ and 225″.

The IEEE 802.11 Wireless LAN MAC protocol 206, under the control of the protocol handler 225, sends a copy of the service discovery message in its original form to the peer devices, as provided by the service discovery protocol module (Zeroconf/UPnP) 210. One copy of service discovery message is sent as per each WLAN channel in use, e.g., channel 1 and channel 2.

In the Zeroconf service discovery protocol 210, this service discovery operation results in service responses from peer devices containing a DNS/multicast DNS (DNS/mDNS) pointer (PTR) record, which specifies the service instance name, the intended stable identifier for any given instance of a service established by the service provider for each WLAN channel in use.

Alternately, in the UPnP protocol, the service discovery operation results in Simple Service Discovery Protocol (SSDP) Search Responses, which specify descriptive URLs pointing to the services in each channel.

In step 438, the protocol handling module 225, upon the first successful creation of a WLAN connection during the service discovery phase, keeps the WLAN connection open for the upper layers 202 and 204 of the IP protocol stack. Even when moving from one WLAN ad hoc network to another, the protocol handling module 225 keeps the WLAN connection open for the upper layers 202 and 204 by buffering transmission requests for a later phase when connection to the new network has been created. The connection is kept open during the whole discovery phase, so that only one TCP connection and IP address are required for the device.

The IEEE 802.11 Wireless LAN MAC protocol 206, under the control of the protocol handler 225, collects these service discovery responses from the WLAN channels used, e.g., channel 1 and channel 2. These responses are sent by the protocol handler 225 to the Zeroconf service discovery protocol 210, which initiated the service discovery operation. As a result, the Zeroconf/UPnP service discovery protocol 210, which initiated the service discovery, sees the discovered services as belonging to the same network.

In step 440, the protocol handling module 225, after the discovery phase, selects a first WLAN ad hoc network to which a WLAN connection is to be created. In the network selection, those networks and devices that have a corresponding protocol handler 225′ and 225″ are given a higher priority and are selected first.

In step 442, the protocol handling module 225 commands the MAC layer 206 to connect to a given WLAN ad hoc network that was detected in the discovery phase. The device uses the same TCP connection and IP address that was used for the device in the service discovery phase.

In step 444, in WLAN connection management, when a service and an associated WLAN ad hoc network and device are selected from the services that were previously detected during the discovery phase, the protocol handling module 225 commands the IEEE 802.11 WLAN medium access control (MAC) layer 206 in the IP protocol stack to connect to the network. For the upper layers 202 and 204 of the IP protocol stack, the protocol handler keeps the WLAN connection open while the MAC layer 206 is connecting to the selected network.

In step 446, the protocol handling module 225 updates the service table 250 accordingly and starts using the peer device's address associated with the selected network and channel offering the service.

Thus, only one TCP connection and IP address are required for the entire lifetime of the application running on the device. Upon the first successful creation of a WLAN connection during the service discovery phase, the protocol handler keeps the WLAN connection open for the upper layers of the IP protocol stack. When moving from one WLAN ad hoc network to another, the protocol handler keeps the WLAN connection open for the upper layers by buffering transmission requests for a later phase when connection to the new network has been created. The protocol handler keeps the WLAN connection open throughout the whole discovery phase. In WLAN connection management, when a service and an associated WLAN ad hoc network and device are selected from the services that were previously detected during the discovery phase, the protocol handler keeps the WLAN connection open for the upper layers 202 and 204 of the IP protocol stack, while the MAC layer 206 is connecting to the selected network. This procedure makes possible requiring only one TCP connection and IP address for the entire lifetime of the application running on the device.

In service discovery operation, Protocol handling module 225 initially receives a single service discovery protocol message from a service discovery protocol (Zeroconf/UPnP) 210 entity residing above. The IEEE 802.11 Wireless LAN MAC protocol 206 then sends a copy of this service discovery message in its original form. One copy of service discovery message is sent as per each WLAN channel in use, e.g., channel 1 and channel 2. In the Zeroconf service discovery protocol 210, this operation results in service responses containing a DNS/multicast DNS (DNS/mDNS) pointer (PTR) record, which specifies the service instance name, the intended stable identifier for any given instance of a service established by the service provider for each WLAN channel in use. In the UPnP protocol, the service discovery operation results in Simple Service Discovery Protocol (SSDP) Search Responses, which specify descriptive URLs pointing to the services in each channel.

With the support from the IEEE 802.11 Wireless LAN MAC protocol 206, the Protocol handling module 225 collects these service discovery responses from WLAN channels used, e.g., channel 1 and channel 2. These responses are sent to the Zeroconf service discovery protocol 210, which initiated the service discovery operation. As a result, the Zeroconf/UPnP service discovery protocol 210, which initiated the service discovery, sees the discovered services as belonging to the same network.

FIG. 2E illustrates the service tables 250, 250′, and 250″ to provide linkage between services, devices, and WLAN channels in each respective wireless device 100, 100′ and 100″.

Example Server Mode for Device 100

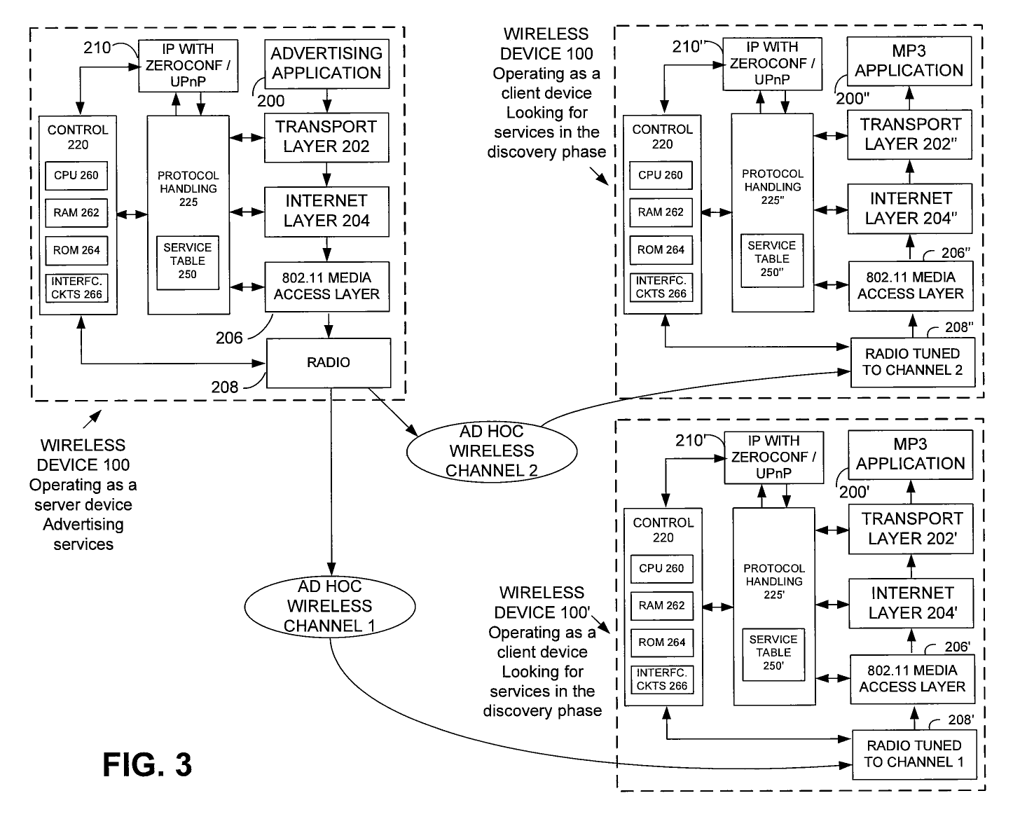

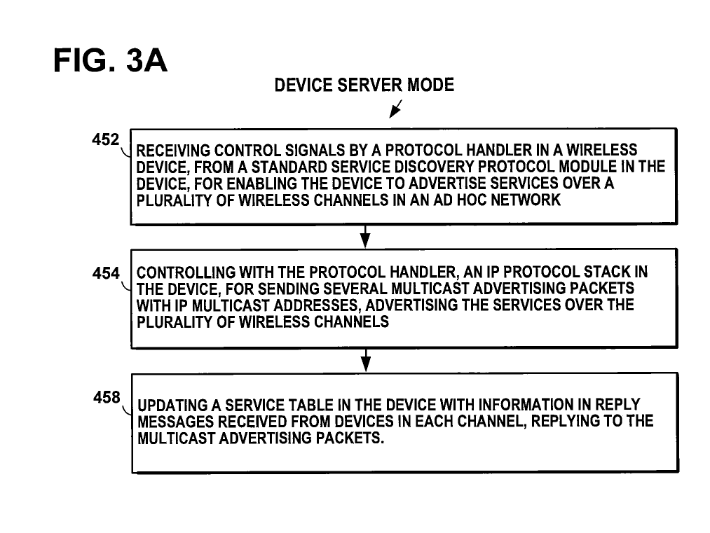

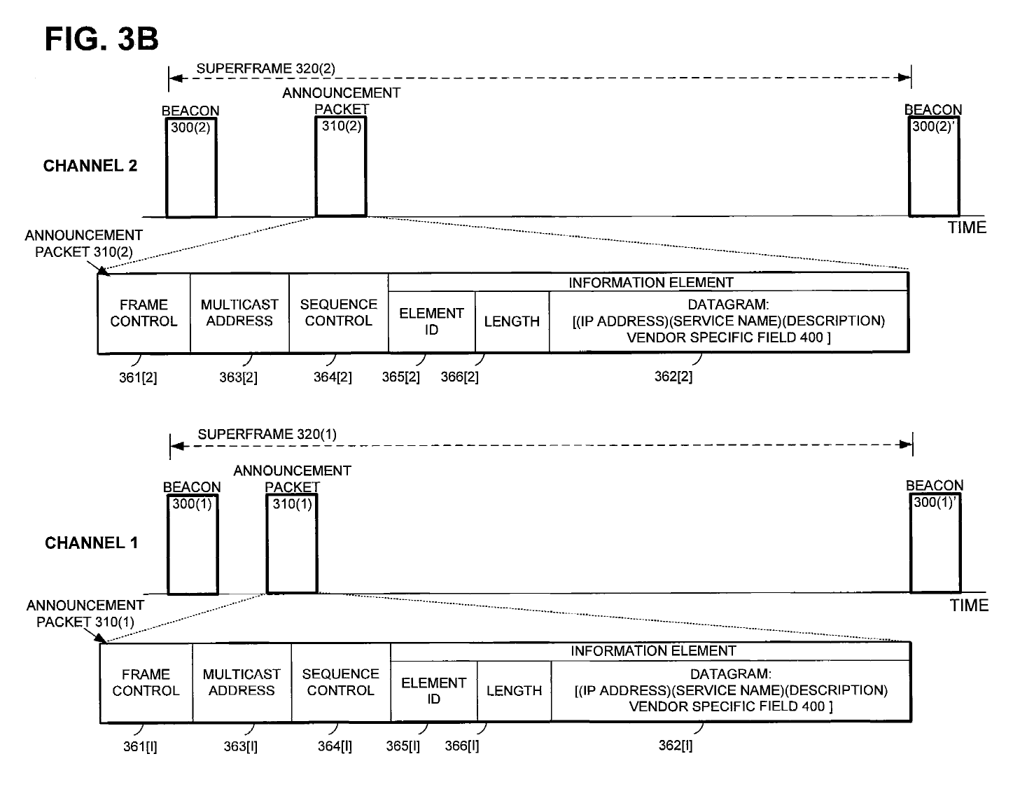

In the embodiment of FIG. 3, the wireless device 100 is operating as a server device running an advertising application 200 and sending out announcement messages about the availability of its services over two different channels, 1 and 2. The wireless devices 100′ and 100″ in FIG. 3 are operating as client devices running respective MP3 audio applications 200′ and 200″ and are searching for services in the discovery phase. Device 100′ is searching on channel 1 and device 100″ is searching on channel 2. The wireless devices 100′ and 100″ in FIG. 3 have similar architectures to device 100.

FIG. 3 illustrates a functional block diagram of the three wireless devices 100, 100′, and 100″. The wireless device 100 is operating as a server device running an advertising application 200 and sending out announcement messages about the availability of its services over two different channels, 1 and 2. The wireless devices 100′ and 100″ are operating as client devices running respective MP3 audio applications 200′ and 200″ and are searching for services in the discovery phase. In DNS Service Discovery, when a service starts up on the device 100 operating in the server mode in FIG. 3, the standard service discovery protocol module 210 in the server device 100 signals the protocol handler 225 coupled between the standard service discovery protocol module 210 and the internet protocol stack 202, 204, 206, to control the IP protocol stack for each channel of the server device 100 to send several multicast announcement packets with IP multicast addresses to enable all client ad hoc wireless devices on each channel, such as client devices 100′ and 100″ in FIG. 3, to become aware of the new service, before the clients are scheduled to perform their next scheduled query. The protocol handler 225′ and 225″ in each client device 100′ and 100″ in FIG. 3, updates its respective service table 250′ and 250″ of available services, with the received information in the multicast announcement packets, to add the new service available from the server device 100 in FIG. 3.

Client device 100′ of FIG. 3 is searching on channel 1 and client device 100″ is searching on channel 2. The wireless devices 100′ and 100″ are receiving from server device 100 multicast announcement packets, respectively, on ad hoc wireless channel 1 and ad hoc wireless channel 2. The multicast announcement packet is received in each respective wireless device 100′/100″ under the control of a respective Internet protocol stack that includes a transport layer 202′/202″, an Internet layer 204′/204″, and an IEEE 802.11 WLAN MAC layer 206′/206″. Each Internet protocol stack is controlled by a respective Protocol handling module 225′/225″ that maps the protocols in a respective Zeroconf/UPnP service discovery protocol module 210′/210″ optimally to the respective Internet protocol stack 202′/202″, 204′/204″, 206′/206″ with the IEEE 802.11 Wireless LAN MAC protocol 206′/206″ as the network interface layer. The respective Protocol handling module 225′/225″ maintains a respective service table 250′/250″ to provide linkage between services, devices, WLAN channels and WLAN ad hoc networks in each wireless device 100′/100″.

FIG. 3A is a simplified flow diagram of an example of the Device Server Mode in an embodiment of the invention.

In step 452, the protocol handling module 225 receives control signals from a standard service discovery protocol module in the device, for enabling the device to advertise services over a plurality of wireless channels in an ad hoc network.

In step 454, the protocol handling module 225 controls an IP protocol stack in the device, for sending several multicast advertising packets with IP multicast addresses, advertising the services over the plurality of wireless channels.

In step 458, the protocol handling module 225 updates a service table in the device with information in reply messages received from devices in each channel, replying to the multicast advertising packets.

FIG. 3B illustrates a timing diagram for server device 100 transmitting the first multicast announcement packet 310(1) on channel 1 and a timing diagram for transmitting the second multicast announcement packet 310(2) on channel 2. Each multicast announcement packet 310 is assembled by the MAC network interface layer 206 and includes a MAC frame control header 361, a multicast address field 363, a sequence control field 364, an element ID field 365, a length field 366, and an information element field 362, which carries the payload for the packet in the form of the datagram passed from the Internet layer 204 above the MAC network interface layer 206. The Beacon frame 300 in FIG. 3B is transmitted periodically every superframe 320, and establishes the timing to allow mobile wireless devices to transmit their multicast announcement packets 310 on their respective channels in scheduled time slots. The protocol handler 225 coupled between the standard service discovery protocol module 210 and the internet protocol stack 202, 204, 206, manages transmitting the first multicast announcement packet 310(1) on channel 1 and a timing diagram for transmitting the second multicast announcement packet 310(2) on channel 2.

The multicast announcement packet 310 is transmitted by server device 100 on each respective channel under the control of the Internet protocol stack that includes the transport layer 202, the Internet layer 204, and the IEEE 802.11 WLAN MAC layer 206. The Internet protocol stack is controlled by the Protocol handling module 225 that maps the protocols in the Zeroconf/UPnP service discovery protocol module 210 optimally to the Internet protocol stack 202, 204, 206 with the IEEE 802.11 Wireless LAN MAC protocol 206 as the network interface layer. The Protocol handling module 225 maintains the service table 250 to provide linkage between services, devices, and WLAN channels.

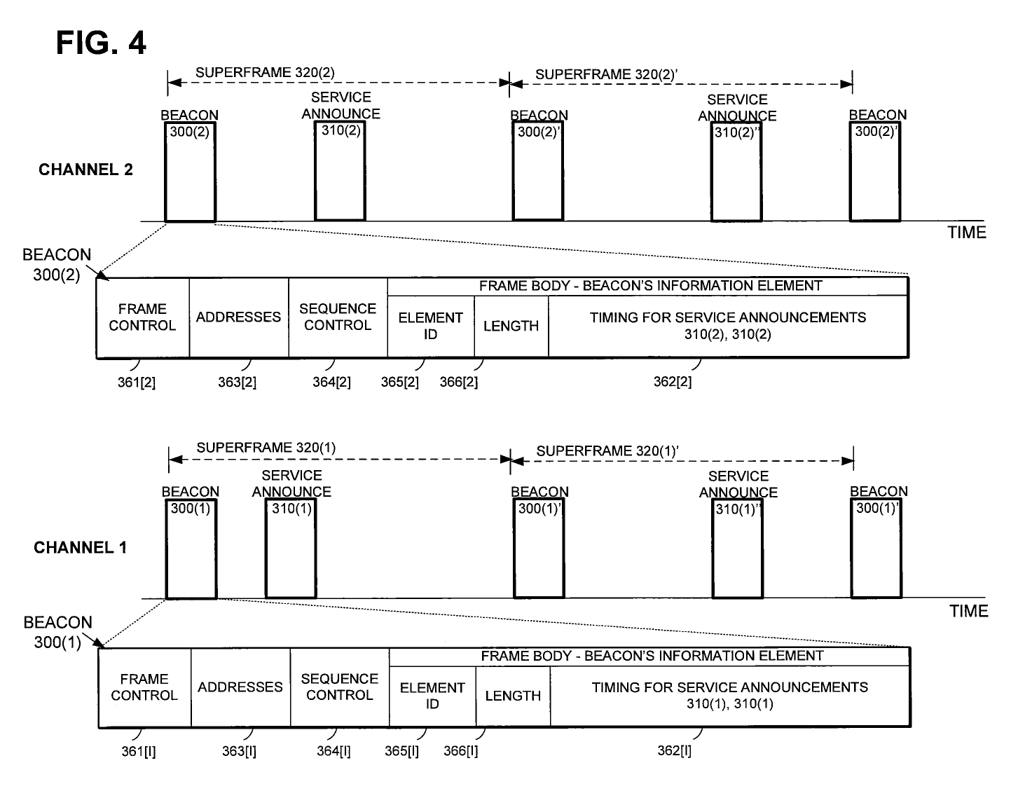

FIG. 4 illustrates using the beacon frame 300 to send a forecast of the timing for transmissions of service announcements. Standard (Zeroconf//UPnP) service announcement frames 310 are periodically transmitted, independently from other devices. The periodic service announcement frames are transmitted in a period that is an integer multiple of the beacon interval superframe 320 and preferably very soon after a beacon is transmitted. On the receiving side, a device scanning for ad hoc networks or ad hoc devices offering interesting services will be able to easily detect these service announcements 310 with passive scanning. In certain existing implementations where only beacons and probe responses are addressed in the scan phase, the scan command can be modified to enable the device to request a scan on the specific service type identified in the beacon. It is not necessary for standard protocol sets (Zeroconf/UPnP) to be active while the WLAN stack is commanded to scan for services.

Optionally, the beacon frame 300 includes supporting information in vendor specific fields 400 to indicate the presence of service announcements. Advertisements are transmitted less frequently than beacons it is beneficial for scanners to know from the beacon information whether to wait for such announcements. The Vendor specific field 400 provides timing information 362 related to the service announcements, which can be specified either as an absolute announcement interval or as a relative interval to the next announcement. With this forecasting information, scanning devices can schedule their own operations more efficiently to save power or to run other services. Alternatively, vendor specific fields 400 are used to indicate the presence of the protocol handling entity in the beaconing device and in the WLAN ad hoc network. The same field that is used to indicate the presence of service announcements may be used. The field can be also used to indicate the presence of the protocol handling entity without the presence of service announcements timed with the beacons. Alternatively, vendor specific fields 400 can simply indicate that there is a protocol handling entity in the beaconing device. Alternatively, it is possible not to transmit service announcements periodically and automatically, but only on request based on the service discovery protocols.

The receiver side passes the service announcement frames through the Protocol handling module 225 for further processing. The Protocol handling module 225 will again ensure that the Transport Layer 202 and the Internet Layer 204 above the IEEE 802.11 Wireless LAN MAC protocol layer 206 gets these announcements in proper manner and at proper time.

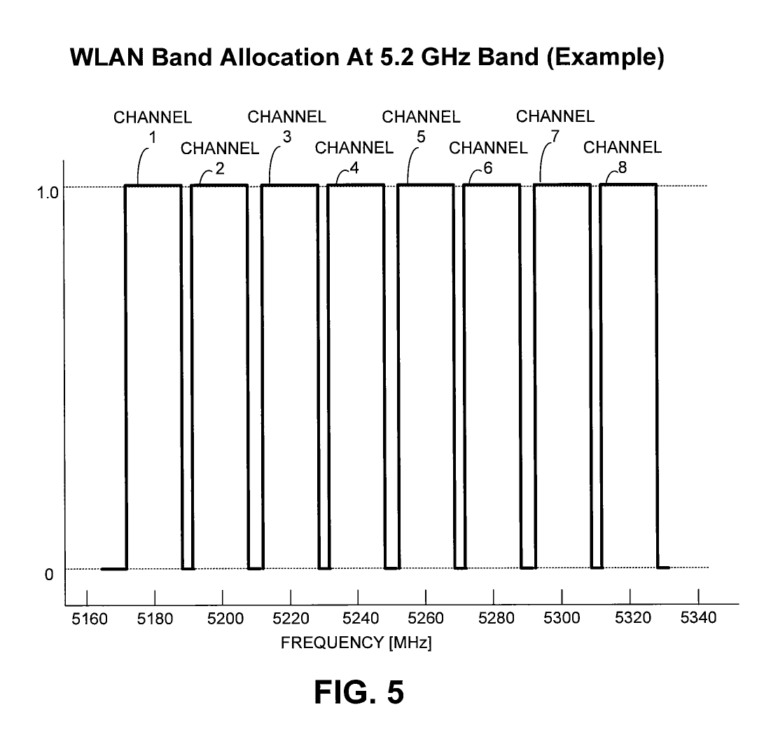

FIG. 5 illustrates an example frequency spectrum for WLAN Band Allocation of channels in the 5.2 GHz Band.

### CONCLUSION

The resulting embodiments provide an improvement in network performance for ad hoc WLANs and better conservation of power in the service discovery phase.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. An apparatus, comprising:
a protocol handler coupled to a service discovery protocol module and at least one internet protocol stack configured for exchanging service discovery packets over at least one channel of an ad hoc wireless network;
a service table coupled to the protocol handler configured for storing information on relationships between available services, wireless devices, and channels on the ad hoc wireless network;
said protocol handler configured for receiving a service discovery protocol inquiry message from the service discovery protocol module and transferring one or more inquiry messages corresponding to the received service discovery protocol inquiry message to the at least one internet protocol stack for respective transmission over the at least one channel of the ad hoc wireless network;
said protocol handler further configured for receiving at least one service response message from the at least one internet protocol stack, the message including information relating to services available from wireless devices operating on the at least one channel of the ad hoc wireless network, and storing the information in said service table about the services indicated as available in the response message.

2. The apparatus of claim 1, wherein
said protocol handler is further configured for receiving a service discovery protocol announcement message from the service discovery protocol module and transferring one or more announcement messages corresponding to the received service discovery protocol announcement message to the internet protocol stack for respective transmission over the at least one channel of the ad hoc wireless network.

3. The apparatus of claim 2, further comprising:
the at least one internet protocol stack configured for transmitting a beacon packet over the at least one channel of the ad hoc wireless network, specifying times for transmission of the service discovery protocol announcement message.

4. The apparatus of claim 1, further comprising:
said service discovery protocol being one of a Zero Configuration Networking protocol and a Universal Plug and Play protocol.

5. The apparatus of claim 1, further comprising:
said protocol handler configured for controlling ad hoc network discovery and detecting ad hoc networks formed by other devices having a corresponding protocol handler;
said protocol handler configured for selectively prioritizing service discovery based on discovery of said other devices in the network having said corresponding protocol handlers.

6. The apparatus of claim 1, further comprising:
said protocol handler configured for running service discovery protocol with another device's corresponding protocol handler;
said protocol handler configured for mapping service discovery protocol messages from the another device's corresponding protocol handler to Zero Configuration Networking or Universal Plug and Play protocol messages.

7. A method, comprising:
receiving in a protocol handler in a wireless device, a service discovery protocol inquiry message from a service discovery protocol module in the wireless device, and transferring one or more inquiry messages corresponding to the received service discovery protocol inquiry message to at least one internet protocol stack for transmission over at least one channel of a first ad hoc wireless network;
exchanging service discovery packets over at least one channel of the first ad hoc network;
maintaining upper layers of the internet protocol stack open to enable exchanging service discovery packets over at least one channel of a second ad hoc network;
receiving in the protocol handler at least one service response message from the at least one internet protocol stack, the response message including information relating to services available from wireless devices operating on the at least one channel of either the first or the second ad hoc wireless network; and
storing the information in a service table coupled to the protocol handler, on services indicated as available in the response message and on relationships between available services, wireless devices, and channels on the ad hoc wireless networks.

8. The method of claim 7, further comprising:
receiving a service discovery protocol announcement message with said protocol handler from the service discovery protocol module and transferring one or more announcement messages corresponding to the received service discovery protocol announcement message to the at least one internet protocol stack for transmission over the at least one channel of the ad hoc wireless network.

9. The method of claim 8, further comprising:
respectively transmitting a beacon packet from the at least one internet protocol stack over the at least one channel of the ad hoc wireless network, specifying times for transmission of the service discovery protocol announcement message.

10. The method of claim 7, further comprising:
said protocol handler running service discovery protocol with another device's corresponding protocol handler;
said protocol handler mapping service discovery protocol messages from the another device's corresponding protocol handler to Zero Configuration Networking or Universal Plug and Play protocol messages.

11. A computer program product, comprising:
a computer readable medium containing program code executable on a data processor;
program code in said computer readable medium for receiving in a protocol handler in a wireless device, a service discovery protocol inquiry message from a service discovery protocol module in the wireless device, and transferring one or more inquiry messages corresponding to the received service discovery protocol inquiry message to at least one internet protocol stack for transmission over at least channel of a first ad hoc wireless network;
program code in said computer readable medium for exchanging service discovery packets over at least one channel of a first ad hoc WLAN network;
program code in said computer readable medium for maintaining upper layers of the internet protocol stack open to enable exchanging service discovery packets over at least one channel of a second ad hoc WLAN network;
program code in said computer readable medium for receiving in the protocol handler at least one service response message from the at least one internet protocol stack, the response message including information relating to services available from wireless devices operating on the at least one channel of either the first or the second ad hoc wireless network; and
program code in said computer readable medium for storing the information in a service table coupled to the protocol handler, on services indicated as available in the response message and on relationships between available services, wireless devices, and channels on the ad hoc wireless networks.

12. The computer program product of claim 11, further comprising:
program code in said computer readable medium for running with said protocol handler a service discovery protocol with another device's corresponding protocol handler;
program code in said computer readable medium for mapping with said protocol handler service discovery protocol messages from the another device's corresponding protocol handler to Zero Configuration Networking or Universal Plug and Play protocol messages.

13. A method comprising:
receiving signals in a protocol handler in a wireless device, from a service discovery protocol module in the device, for enabling the device to query a plurality of wireless channels in an ad hoc network, to determine what services are available in the network; and
controlling with the protocol handler, an IP protocol stack in the device, for sending service discovery queries over the plurality of wireless channels.

14. The method of claim 13, further comprising:
said protocol handler checking for existing network services for each channel in a service table in the device, and passing addresses of existing network services to the IP protocol stack.

15. A method comprising:
receiving signals in a protocol handler in a wireless device, from a service discovery protocol module in the device, for enabling the device to advertise services over a plurality of wireless channels in an ad hoc network; and
controlling with the protocol handler, an IP protocol stack in the device, for sending packets advertising the services over the plurality of wireless channels.

16. The method of claim 15, further comprising:
said protocol handler controlling the IP protocol stack for each channel of the device to send several multicast advertising packets with IP multicast addresses, advertising the services to other wireless devices on the channel.

17. The method of claim 16, further comprising:
said protocol handler updating a service table in the device with information in reply messages received from devices in each channel, replying to the multicast advertising packets.

18. A method comprising:
receiving link-local addressing signals in a protocol handler in a wireless device, from a service discovery protocol module in the device, for enabling the device to select a trial address at random for one or more of a plurality of channels in an ad hoc network; and
controlling with the protocol handler, an IP protocol stack in the device, for sending packets containing the trial address over each of the plurality of wireless channels to test whether any other ad hoc wireless device within range on the same channel, uses the same trial address.

19. The method of claim 18, further comprising:
selecting, by said service discovery protocol module, the trial address at random for one or more of the plural channels, and said protocol handler recording each of the trial addresses in a service table and passing each trial address to the IP protocol stack.

20. The method of claim 18, further comprising:
sending an Address Resolution Protocol (ARP) request packet on each respective channel, to test whether any other ad hoc wireless device within range on the same channel, uses the same trial address.

21. The method of claim 20, further comprising:
determining that no responses have been received indicating another device has the same address on a respective channel;
recording in the service table that the trial address is confirmed as being a valid address for use by the device on that channel.

22. A method comprising:
receiving Multicast DNS signals in a protocol handler in a wireless device, from a service discovery protocol module in the device, for enabling the device to select a trial device name for one or more of a plurality of channels in an ad hoc network; and
controlling with the protocol handler, an IP protocol stack in the device, for sending packets containing the trial device name over each of the plurality of wireless channels to test whether any other ad hoc wireless device within range on the same channel, uses the same trial device name.

23. The method of claim 22, further comprising:
recording each of the trial device names in a service table and passing each trial device name to the IP protocol stack.

24. The method of claim 23, further comprising:
sending a multicast DNS query packet with the trial device name to test whether any other ad hoc wireless device within range on the same channel, uses the same trial device name.

25. The method of claim 24, further comprising:
determining that no responses have been received indicating another device has the same device name on a respective channel;
recording in the service table that the trial device name is confirmed as being a valid device name for use by the device on that channel.

26. A method, comprising:
receiving signals in a protocol handling module in a wireless device, from a service discovery protocol module in the device;
commanding with the protocol handling module, a medium access control (MAC) layer in an IP protocol stack to perform WLAN scan in selected channels;
prioritizing with the protocol handling module, service discoveries with peer devices that have a corresponding protocol handler indicated by their transmissions, before the protocol handling module interacts with other devices that do not have a corresponding protocol handler;
running a service discovery phase with the protocol handling module, wherein service discovery occurs first in networks having peer devices that have a similar protocol handler;
commanding with the protocol handling module, the medium access control (MAC) layer in the IP protocol stack to establish a WLAN connection; and
selecting with the protocol handling module after the discovery phase, a target WLAN ad hoc network to which a WLAN connection is created or maintaining an existing WLAN connection to a target WLAN ad hoc network, said protocol handling module giving a higher priority to target WLAN ad hoc networks having devices with a corresponding protocol handling module.

27. The method of claim 26, further comprising:
commanding with the protocol handling module, the MAC layer to connect to a given WLAN ad hoc network that was detected in the discovery phase; and
keeping the WLAN connection open for upper layers of the IP protocol stack upon a first successful creation of the WLAN connection during the service discovery phase.

28. The method of claim 27, further comprising:
commanding the MAC layer in the IP protocol stack to connect to the network when a service and an associated WLAN ad hoc network and device are selected from the services detected during the discovery phase; and
updating the service table with the protocol handling module, and starting using the address associated to the selected network and channel with the service.

29. An apparatus, comprising:
a protocol handler coupled to a service discovery protocol module and at least one internet protocol stack configured for exchanging service discovery packets over at least one channel of an ad hoc wireless network;
said protocol handler configured for receiving signals from the service discovery protocol module;
a service table coupled to the protocol handler configured for storing information on relationships between available services, wireless devices, and channels on the ad hoc wireless network;
said protocol handler configured for commanding the at least one internet protocol stack to perform WLAN scan in selected channels;
said protocol handler configured for commanding the at least one internet protocol stack to establish a WLAN connection and perform WLAN service discoveries in selected channels during a discovery phase;
said protocol handler configured for prioritizing service discoveries with peer devices that have a corresponding protocol handler, before the protocol handling module interacts with other devices that do not have one;
said protocol handler configured for running a service discovery phase, wherein service discovery occurs first in networks having peer devices transmitting information indicating that the peer devices have a similar protocol handler; and
said protocol handler configured for selecting, after the discovery phase, a target WLAN ad hoc network to which a WLAN connection is created or maintaining an existing WLAN connection to a target WLAN ad hoc network, said protocol handler configured for giving a higher priority to target WLAN ad hoc networks having devices with a corresponding protocol handler.

30. A computer program product, comprising:
a computer readable medium containing program code executable on a data processor;
program code in said computer readable medium for receiving signals in a protocol handling module in a wireless device, from a service discovery protocol module in the device;
program code in said computer readable medium for commanding with the protocol handling module, a medium access control (MAC) layer in the IP protocol stack to perform WLAN scan in selected channels;
program code in said computer readable medium for prioritizing with the protocol handling module, service discoveries with peer devices that have a corresponding protocol handler indicated by their transmissions, before the protocol handling module interacts with other devices that do not have a corresponding protocol handler;
program code in said computer readable medium for running with the protocol handling module, service discovery first in networks having peer devices that have a similar protocol handler during a discovery phase;
program code in said computer readable medium for commanding with the protocol handling module, the medium access control (MAC) layer in the IP protocol stack to establish a WLAN connection; and
program code in said computer readable medium for selecting with the protocol handling module after the discovery phase, a target WLAN ad hoc network to which a WLAN connection is created or maintaining an existing WLAN connection to a target WLAN ad hoc network, said protocol handling module giving a higher priority to target WLAN ad hoc networks having devices with a corresponding protocol handling module.

31. A method, comprising:
determining link local addresses common for all networks or channels for a discovery phase, using a protocol handler coupled to a service discovery protocol module and at least one internet protocol stack in a wireless device;
recording information about services provided by the wireless device itself;
detecting ad hoc networks formed by other devices having a similar protocol handler;
prioritizing service discoveries with those other devices having a similar protocol handler before performing service discoveries with devices that do not have one;
running a service discovery protocol with a similar protocol handler in one of said other devices; and
providing network interface services to the IP stack and the service discovery protocol by mapping service discovery protocol messages from the other device's similar protocol handler to service discovery protocol messages.

32. An apparatus, comprising:
a protocol handler in a wireless device configured for receiving signals from a service discovery protocol module in the device, the protocol handler further configured for enabling the device to query a plurality of wireless channels in an ad hoc network, to determine what services are available in the network; and
an IP protocol stack in the device controlled with the protocol handler, the IP protocol stack configured for sending service discovery queries over the plurality of wireless channels.

33. The apparatus of claim 32, further comprising:
said protocol handler configured for checking for existing network services for each channel in a service table in the device, and further configured for passing addresses of existing network services to the IP protocol stack.

34. An apparatus, comprising:
means for exchanging service discovery packets over at least one channel of an ad hoc wireless network;
means for storing information on relationships between available services, wireless devices, and channels on the ad hoc wireless network into a service table;
means for receiving a service discovery protocol inquiry message from a service discovery protocol module and transferring one or more inquiry messages corresponding to the received service discovery protocol inquiry message to at least one internet protocol stack for respective transmission over the at least one channel of the ad hoc wireless network;
means for receiving at least one service response message from the at least one internet protocol stack, the message including information relating to services available from wireless devices operating on the at least one channel of the ad hoc wireless network, and storing the information in said service table about the services indicated as available in the response message.
